(19) United States
(12) Patent Application Publication
(10) Pub. No.: US 2015/0293517 A1
(43) Pub. Date: Oct. 15, 2015

(54) MOBILE APPLICATION AND CONTROL SYSTEM

(71) Applicant: Adam Chase Higgins, Elko, NV (US)

(72) Inventor: Adam Chase Higgins, Elko, NV (US)

(21) Appl. No.: 14/248,482

(22) Filed: Apr. 9, 2014

(51) Int. Cl. G05B 19/05; H02J 13/00

(52) U.S. Cl. CPC G05B 19/058; H02J 13/00

(57) ABSTRACT

A system for controlling power distribution including: a mobile software application, where said application is installed on at least one portable electronic device; a Wi-Fi network; programmable logic controllers (PLC), where the PLC's are placed on circuit breakers throughout a power distribution system; and signals sent between the PLC's and the at least one portable electronic device, wherein said signals include control commands between the at least one portable electronic device to the PLC's, and status signals from the PLC's to the at least one portable electronic device indicating status of respective circuit breakers in the power distribution system, wherein said signals are transmitted over the Wi-Fi network.

### BACKGROUND OF THE INVENTION

1. Field of Invention

The present invention relates to a mobile application and control system to control circuits and circuit breakers in an industrial or commercial environment.

2. Description of Related Art

Industrial and commercial buildings usually require a significant amount of electrical power to operate. Industrial plants usually have various machines for production purposes that use electrical power. The general power distribution throughout an industrial plant requires numerous circuit breakers to control power distribution and for safety purposes in relation to the operation of the machinery.

Commercial buildings also require numerous circuit breakers due to the lighting and facilities management of the power distribution that based upon location. For example casinos in particular require a significant amount of electrical power for operation due to the nature of the business and the requirement for heavy electrical power to operate the gaming machinery. Safety and maintenance personnel are normally required and responsible for power distribution and safety in such facilities. Some control systems exist for such facilities but normally a centrally located room or system is positioned in the facility to control the power distribution and circuit breakers throughout the facility. As a consequence, it would be advantageous to have a mobile application that may be integrated into a smart phone for use by safety and maintenance personnel. The application could advantageously provide information regarding circuit activity and circuit breakers connections throughout the particular facility. Further it would be advantageous to have such a device that controls the breakers through the use of the mobile application provided.

### SUMMARY OF THE INVENTION

The present invention relates to a system for controlling power distribution comprising: a mobile software application, where said application is installed on at least one portable electronic device; a Wi-Fi network; programmable logic controllers (PLC), where the PLC's are placed on circuit breakers throughout a power distribution system; and signals sent between the PLC's and the at least one portable electronic device, wherein said signals include control commands between the at least one portable electronic device to the PLC's, and status signals from the PLC's to the at least one portable electronic device indicating status of respective circuit breakers in the power distribution system, wherein said signals are transmitted over the Wi-Fi network.

### BRIEF DESCRIPTION OF DRAWINGS

FIG. 1 depicts a typical circuit breaker arrangement with programmable logic control systems.

FIG. 2 depicts use of a mobile application in accordance with the present invention to control a circuit breaker system within a facility.

### DETAILED DESCRIPTION

The present invention relates to a mobile application that's integrated into a smart phone, tablet or other portable computer applications in order to control electrical distribution and in particular electrical circuit breakers through use of the mobile application. The mobile application receives signals and transmits signals through a Wi-Fi network within range of the particular circuit breakers that are controlled within the application. Software designed to enable the application is installed on the mobile electronic device and communicates with a programmable logic control input. The logic control input may control a series of circuit breakers with in the Wi-Fi network. The Wi-Fi control signals are received by the logic controller and therefore capable of turning on and off circuit breakers within a typical circuit breaker panel.

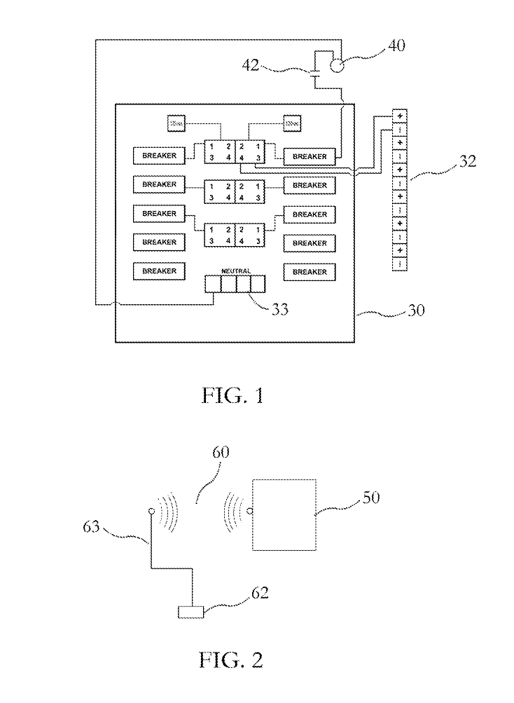

In reference to FIG. 1, a Circuit Breaker Panel 30 is depicted. The Circuit Breaker Panel 30 includes a programmable logic control (PLC) Output Card 32. The PLC Output Card 32 is capable of controlling the Circuit Breaker Array 33 shown in the Circuit Breaker 30. In this particular example a Motor 40 is controlled through the Circuit Breaker 30 with a PLC Internal Contact 42 connecting to the Motor 40. The Circuit Breaker 30 may be controlled by a mobile application installed on a Portable Electronic Device 50 shown in FIG. 2. The portable electronic device may be a smart phone cell phone, tablet or other portable computing device such as a small laptop. The application includes software instructions that are capable of controlling a PLC Input 62 as shown in FIG. 2. During operation the software may transmit signals via a Wi-Fi Network 60 as shown in FIG. 2, which is received through an Input 63 for the PLC Input 62. This PLC input 62 communicates with the Circuit Breaker 30 as shown in FIG. 1. During operation a user may view the operation of the Circuit Breaker 30 in addition to a plurality of circuit breakers within an electrical distribution system. As these breakers are displayed on the Mobile Device 50 a user may input control commands for controlling the operation of the circuit breakers and therefore control the electrical distribution of the entire system through the Wi-Fi Network 60. The operation of the present invention as a consequence enables maintenance and safety personnel to control numerous breakers and electrical distribution in a more efficient manner and also reduce actual physical contact with the breakers due to the use of the PLC connections provided. The electrical distribution control system is therefore managed wirelessly and efficiently through the use of the mobile application in accordance with the present invention. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for controlling power distribution comprising:
a. a mobile software application, where said application is installed on at least one portable electronic device;
b. a Wi-Fi network;
c. programmable logic controllers (PLC), where the PLC's are placed on circuit breakers throughout a power distribution system; and
d. signals sent between the PLC's and the at least one portable electronic device, wherein said signals include control commands between the at least one portable electronic device to the PLC's, and status signals from the PLC's to the at least one portable electronic device indicating status of respective circuit breakers in the power distribution system, wherein said signals are transmitted over the Wi-Fi network.

2. The system for controlling power distribution where the at least one portable electronic device includes at least one of a smart phone cell phone, tablet or a laptop computer.

3. The system for controlling power distribution, where each circuit breaker includes a PLC input, where the PLC input receives signals from the at least one portable electronic device.
